(19) United States
(12) Patent Application Publication
(10) Pub. No.: US 2024/0359911 A1
(43) Pub. Date: Oct. 31, 2024

(54) SYSTEMS FOR DETECTING AND PICKING UP A WASTE RECEPTACLE

(71) Applicant: Oshkosh Corporation, Oshkosh, WI (US)

(72) Inventors: Eric Codega, Oshkosh, WI (US); Leo Van Kampen, Conestogo (CA)

(73) Assignee: Oshkosh Corporation, Oshkosh, WI (US)

(21) Appl. No.: 18/630,531

(22) Filed: Apr. 9, 2024

Related U.S. Application Data
(60) Provisional application No. 63/462,755, filed on Apr. 28, 2023.

(51) Int. Cl. B65F 3/04; B65F 3/02

(52) U.S. Cl. CPC B65F 3/04; B65F 2003/0279

(57) ABSTRACT

A system for detecting a waste receptacle includes a collection assembly and a processor. The collection assembly includes a plurality of interface members configured to engage the waste receptacle and a camera configured to obtain image data associated with a target area proximate the interface members. the processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. The processor is also configured to operate at least one of a lift arm actuator or an articulation actuator of a lift assembly to move the interface members based on the location of the waste receptacle.

### CROSS-REFERENCE TO RELATED PATENT APPLICATION

This application claims the benefit of and priority to U.S. Provisional Patent Application No. 63/462,755, filed Apr. 28, 2023, which is incorporated herein by reference in its entirety.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.). One area of interest with respect to improving collection speed is the automation of the waste receptable pick-up.

### SUMMARY

One embodiment relates to a system for detecting and engaging a waste receptacle. The system includes a collection assembly configured to couple to a refuse vehicle and a processor. The collection assembly includes a plurality of interface members configured to engage the waste receptacle and a camera configured to obtain image data associated with a target area proximate the interface members. The processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. The processor is also configured to operate at least one of a lift arm actuator or an articulation actuator of a lift assembly to move the interface members based on the location of the waste receptacle.

In some embodiments, responsive to the pose candidate not matching the template representation the processor is also configured to limit operation of at least one of the lift arm actuator or the articulation actuator. In some embodiments, the operation of the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into a refuse compartment of the refuse vehicle, lower the waste receptacle, and disengage the waste receptacle, wherein the interface members are positioned to engage the waste receptacle when the interface members are in the engagement position.

In some embodiments, prior to operating the interface members to engage the waste receptacle, the processor is further configured to determine, based on the image data, if the interface members are in the engagement position. In some embodiments, responsive to the interface members not being in the engagement position, the processor is also configured to further operate the at least one of the lift arm actuator or the articulation actuator to move the interface members to the engagement position.

In some embodiments, the camera is a first camera. In some embodiments, the collection assembly further comprises a second camera configured to obtain the image data associated with the target area proximate the interface members.

In some embodiments, the pose candidate is a first pose candidate generated based on the image data of the first camera. In some embodiments, the processor is also configured to generate, based on the image data of the second camera, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine the location of the waste receptacle using the image data obtained by the first camera and the second camera to triangulate the location of the waste receptacle.

In some embodiments, the first camera is coupled to one of the interface members and the second camera is coupled to the refuse vehicle. In some embodiments, the first camera is configured to move with the interface members.

In some embodiments, the pose candidate is a first pose candidate generated based on the image data of the first camera. In some embodiments, the processor is also configured to determine a first pose location of the first pose candidate. In some embodiments, the processor is also configured to generate, based on the image data of the second camera, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location.

In some embodiments, the pose candidate is a first pose candidate generated based on the image data of the camera when the camera is in a first position. In some embodiments, the processor is also configured to determine a first pose location of the first pose candidate. in some embodiments, the processor is also configured to generate, based on the image data of the camera when the camera is in a second position, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location.

Another embodiment relates to a refuse vehicle. The refuse vehicle includes a chassis, a body defining a refuse compartment configured to receive refuse, a lift assembly, a collection assembly coupled to a distal end of the lift arms, and a processor. The lift assembly includes lift arms pivotably coupled to the body, a lift arm actuator coupled between the chassis and the lift arms configured to move the lift arms, and an articulation actuator coupled to the lift arms. The collection assembly includes a plurality of interface members configured to engage a waste receptacle and a camera configured to obtain image data associated with a target area proximate the interface members. The articulation actuator is configured to move the interface members relative to the lift arms. The processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. the processor is also configured to operate at least one of the lift arm actuator or the articulation actuator to move the interface members based on the location of the waste receptacle.

In some embodiments, responsive to the pose candidate not matching the template representation, the processor is also configured to limit operation of at least one of the lift arm actuator or the articulation actuator. In some embodiments, operation of the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into the refuse compartment of the refuse vehicle, lower the waste receptacle, and release the waste receptacle, wherein the interface members are positioned to engage the waste receptacle when the interface members are in the engagement position.

In some embodiments, prior to operating the interface members to engage the waste receptacle, the processor is configured to determine, based on the image data, if the interface members are in the engagement position. In some embodiments, responsive to the interface members not being in the engagement position, the processor is also configured to operate the at least one of the lift arm actuator or the articulation actuator to move the interface members to the engagement position.

In some embodiments, the pose candidate is a first pose candidate generated based on the image data of the camera when the camera is in a first position. In some embodiments, the processor is also configured to determine a first pose location of the first pose candidate. In some embodiments, the processor is also configured to generate, based on the image data of the camera when the camera is in a second position, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location. In some embodiments, responsive to the difference between the first pose location and the second pose location being greater than the location error threshold, the processor is also configured to configured to limit operation of the refuse vehicle.

Yet another embodiment relates to a method for detecting and engaging a waste receptacle. The method includes generating, based on image data obtained by a camera of a collection assembly of a refuse vehicle, a pose candidate located within a target area proximate the interface members. The method also includes verifying if the pose candidate matches a template representation corresponding to the waste receptacle. Responsive to the pose candidate matching the template representation, the method also includes determining a location of the waste receptacle. The method also includes operating at least one of a lift arm actuator configured to move lift arms of the refuse vehicle or an articulation actuator configured to move a plurality of interface members of the collection assembly relative to the lift arms to move the interface members based on the location of the waste receptacle.

In some embodiments, responsive to the pose candidate not matching the template representation, the method also includes limiting operation of at least one of the lift arm actuator or the articulation actuator. In some embodiments, operating the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into a refuse compartment of the refuse vehicle, lower the waste receptacle, and disengage the waste receptacle, wherein the interface members are positioned to engage the waste receptacle when the interface members are in the engagement position.

In some embodiments, prior to operating the interface members to engage the waste receptacle, the method also includes determining, based on the image data, if the interface members are in the engagement position. In some embodiments, responsive to the interface members not being in the engagement position, the method also includes further operating the at least one of the lift arm actuator or the articulation actuator to move the interface members to the engagement position.

In some embodiments, the pose candidate is a first pose candidate generated based on the image data of the camera when the camera is in a first position. In some embodiments, the method also includes determining a first pose location of the first pose candidate. In some embodiments, the method also includes generating, based on the image data of the camera when the camera is in a second position, a second pose candidate located within the target area. In some embodiments, the method also includes verifying if the second pose candidate matches the template representation corresponding to the waste receptacle. In some embodiments, responsive to the second pose candidate matching the template representation, the method also includes determining a second pose location of the second pose candidate. In some embodiments, responsive to a difference between the first pose location and the second pose location being less than a location error threshold, determining that the location of the waste receptacle is at least one of the first pose location, the method also includes determining that the location of the waste receptacle is at least one of the first pose location, the second pose location, or an average of the first pose location and the second pose location.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle, according to an exemplary embodiment;

FIG. 2 is a perspective view of a collection assembly of the refuse vehicle of FIG. 1 engaged with a waste receptacle, according to an exemplary embodiment;

FIG. 3 is a side view the refuse vehicle of FIG. 2, according to an exemplary embodiment;

FIG. 4 is a top view of the refuse vehicle of FIG. 2, according to an exemplary embodiment;

FIG. 5 is a pictorial representation of a waste receptacle and template representation associated with the waste receptacle, according to an exemplary embodiment;

FIG. 6 is a flow diagram depicting a method for creating a representation of an object, according to an exemplary embodiment;

FIG. 7 is a block diagram showing a control system for detecting and picking up a waste receptacle, according to an exemplary embodiment;

FIG. 8 is a flow diagram depicting a method pipeline used to detect and locate a waste receptacle, according to an exemplary embodiment;

FIG. 9 is a flow diagram depicting an example of a modified Line2D gradient-response map method, according to an exemplary embodiment;

FIG. 10 is a pictorial representation of the verify candidate step of a method for detecting and locating a waste receptacle, according to an exemplary embodiment; and

FIG. 11 is a flow diagram depicting a method for detecting and picking up a waste receptacle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a system for detecting and picking up a waste receptacle coupled to a refuse vehicle includes a lift arm coupled to the refuse vehicle, a collection assembly coupled to the lift arm configured to engage the waste receptacle, a processor, a camera in communication with the processor for capturing an image, a database in communication with the processor for storing a template representation corresponding to the waste receptacle, a lift arm actuator in communication with the processor and configured to move the lift arm relative to the refuse vehicle, and an articulation actuator in communication with the processor and configured to move the collection assembly relative to the lift arm. The processor is configured for generating a pose candidate based on the image, and verify whether the pose candidate matches the template representation. The processor is further configured for calculating a location and/or an orientation of the waste receptacle when a match between the pose candidate and the template representation has been verified. The lift arm actuator and the articulation actuator are configured to automatically move the lift arm and/or the collection assembly in response to the calculated location of the waste receptacle. Such a system may advantageously allow an operator to verify the location of the waste receptacle relative to the collection assembly coupled to the lift arm and to align the collection assembly with the waste receptacle without the operator needing to exit the refuse vehicle.

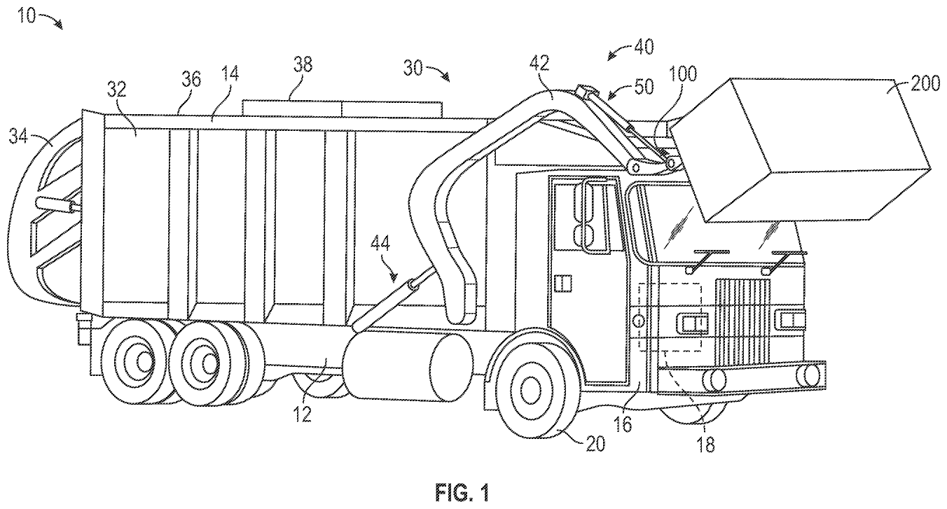

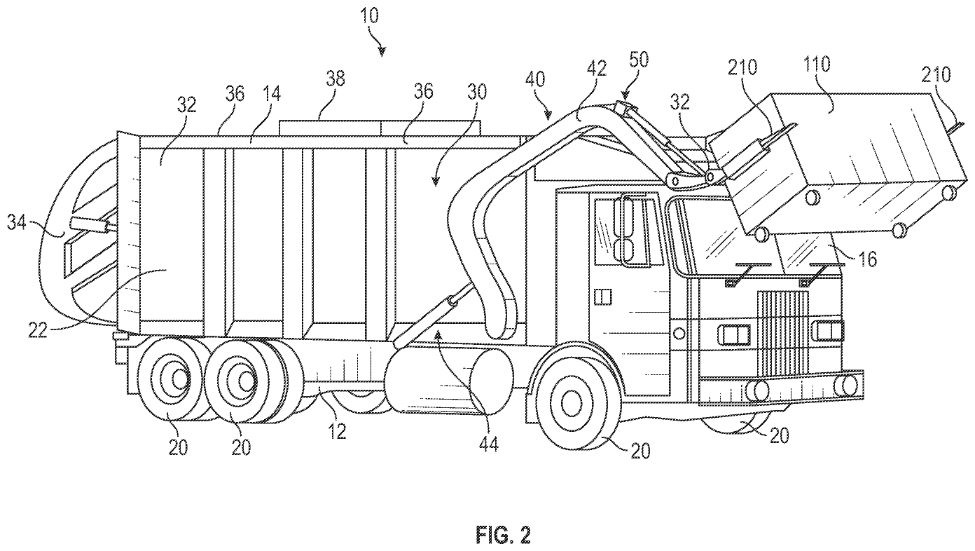

As shown in FIGS. 1 and 2, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIGS. 1 and 2, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIGS. 1 and 2, the refuse vehicle 10 includes a prime mover, shown as engine 18, coupled to the frame 12 at a position beneath the cab 16. The engine 18 is configured to provide power to a plurality of tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, biodiesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIGS. 1 and 2, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIGS. 1 and 2, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment. In other embodiments, the storage volume is positioned between the hopper volume and the cab 16 (e.g., a rear-loading refuse vehicle, etc.).

As shown in FIGS. 1 and 2, the refuse vehicle 10 includes a lift mechanism/system (e.g., a front-loading lift assembly, etc.), shown as lift assembly 40. The lift assembly 40 includes a pair of arms, shown as lift arms 42, coupled to the frame 12 and/or the body 14 on either side of the refuse vehicle 10 such that the lift arms 42 extend forward of the cab 16 (e.g., a front-loading refuse vehicle, etc.). In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). The lift arms 42 may be rotatably coupled to frame 12 with a pivot (e.g., a lug, a shaft, etc.). As shown in FIGS. 1 and 2, the lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment.

As shown in FIGS. 1, an attachment assembly, shown as attachment assembly 100, is coupled to the lift arms 42 of the lift assembly 40. In some embodiments, the attachment assembly 100 is coupled to a distal end of the lift arms 42. As shown in FIGS. 2, the attachment assembly 100 is configured to engage with interfaces, shown as attachment interfaces 219, of a first attachment (e.g., a fork assembly, an engagement assembly, etc.), shown as collection assembly 200, to selectively and releasably secure the collection assembly 200 to the lift assembly 40. According to the exemplary embodiment shown in FIG. 2, the collection assembly 200 is configured to engage a waste receptacle (e.g., a dumpster, a commercial waste receptacle, etc.), shown as waste receptacle 110. In other embodiments, the attachment assembly 100 is configured to engage with one or more additional attachments (e.g., carry can, etc.) to selectively and releasably secure the additional attachments to the lift assembly 40. In still other embodiments, the refuse vehicle 10 does not include the attachment assembly 100 and the collection assembly 200 is coupled directly to the lift assembly 40.

As shown in FIGS. 1 and 2, the lift arms 42 are rotated by the lift arm actuators 44 to lift the collection assembly 200 or other attachments over the cab 16. As shown in FIGS. 1 and 2, the lift assembly 40 includes second actuators, shown as articulation actuators 50 (e.g., hydraulic cylinders, etc.), extending between the lift arms 42 and the attachment assembly 100. According to an exemplary embodiment, the articulation actuators 50 are positioned to articulate the attachment assembly 100. Such articulation may assist in tipping refuse out of the waste receptacle 110 engaged with the collection assembly 200 and into the hopper volume of the refuse compartment 30 through an opening in the cover 36. The lift arm actuators 44 may thereafter rotate the lift arms 42 to return the waste receptacle 110 engaged with the collection assembly 200 to the ground. According to an exemplary embodiment, a door, shown as top door 38 is movably coupled along the cover 36 to seal the opening thereby preventing refuse from escaping the refuse compartment 30 (e.g., due to wind, bumps in the road, etc.).

According to the exemplary embodiment shown in FIG. 2, the collection assembly 200 includes a plurality of interface members (e.g., two of the interface members, etc.), shown as forks 210, coupled to attachment assembly 100. The forks 210 have a generally rectangular cross-sectional shape and are configured to engage the waste receptacle 110 (e.g., protrude through apertures within the waste receptacle, etc.). During operation of the refuse vehicle 10, the forks 210 are positioned to engage the waste receptacle (e.g., the refuse vehicle 10 is driven into position until the forks 210 protrude through the apertures within the waste receptacle). In other embodiments, the forks 210 may have a different cross-sectional shape (e.g., circular, hexagonal, etc.). Generally speaking, the forks 210 may be designed to complement a specific waste receptacle, a specific type of waste receptacle, a general class of waste receptacles, etc. In other embodiments, the collection assembly 200 is configured with a grabber that engages with the waste receptacle 110.

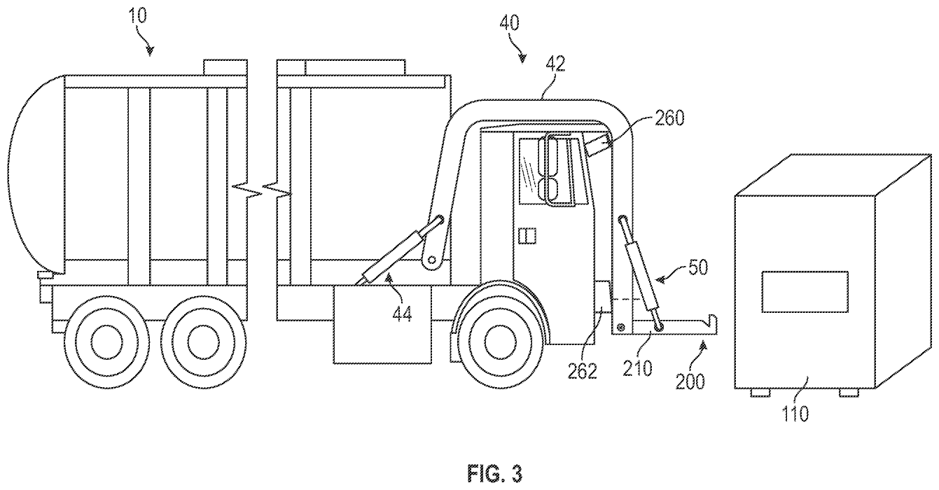

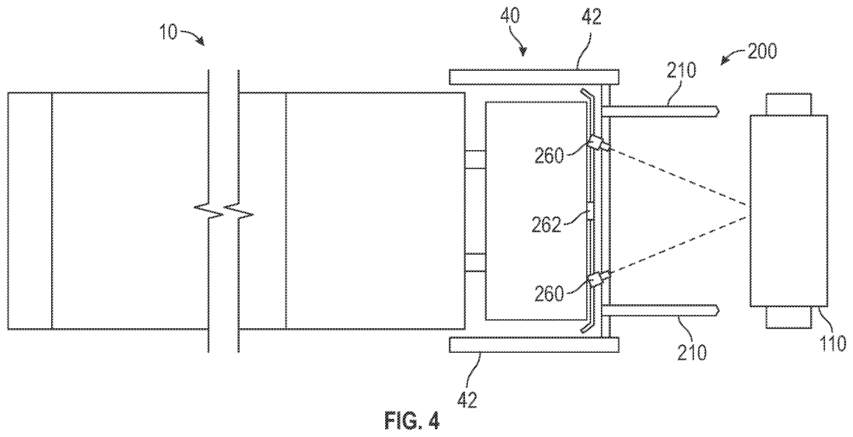

As shown in FIGS. 3 and 4, the collection assembly 200 also includes a plurality of cameras (e.g., image capture devices, image acquisition devices, a first camera and a second camera, etc.), shown as cameras 260, configured to capture an image of a target area proximate the collection assembly 200 (e.g., in front of the collection assembly 200, in front of the refuse vehicle 10 in a direction of travel of the refuse vehicle 10, etc.). In some embodiments, the collection assembly 200 also includes a distance sensor (e.g., an ultrasonic distance sensor, an infrared distance sensor, a laser distance sensor, etc.), shown as distance sensor 262, configured to generate sensor data corresponding to a distance between the distance sensor 262 and an object proximate the collection assembly 200 (e.g., the waste receptacle 110, etc.). In other embodiments, the collection assembly 200 includes one of the cameras 260.

A waste receptacle is a container for collecting or storing garbage, recycling, compost, and other refuse, so that the garbage, recycling, compost, or other refuse can be pooled with other waste, and transported for further processing. Generally speaking, waste may be classified as residential, commercial, industrial, etc. As used here, a “waste receptacle” may apply to any of these categories, as well as others. Depending on the category and usage, a waste receptacle may take the form of a garbage can, a dumpster, a recycling “blue box”, a compost bin, etc. Further, waste receptacles may be used for dumpster collection (e.g., at commercial locations), as well as collection in other specified locations (e.g., in the case of curb-side collection).

According to the exemplary embodiment shown in FIGS. 3 and 4, the cameras 260 are coupled a forward portion of the cab 16 of the refuse vehicle 10 so that, as the refuse vehicle 10 is driven along a path, the cameras 260 can capture images (e.g., real-time images, etc.) of the target area forward of the refuse vehicle 10 along the path of the refuse vehicle 10. The cameras 260 may generate image data associated with the images of the target area. In some embodiments, the camera 260 is otherwise coupled to the cab 16. In various other embodiments, the cameras 260 are coupled to the lift assembly 40, the collection assembly 200, and/or are otherwise coupled to components of the refuse vehicle 10. For example, a first of the cameras 260 may be coupled to the collection assembly 200 (e.g., the forks 210, etc.) and a second of the cameras 260 may be coupled to one of the lift arms 42. As another example, a first of the cameras 260 may be coupled to the cab 16 and a second of the cameras may be coupled to one of the forks 210 of the collection assembly 200.

According to the exemplary embodiment shown in FIGS. 3 and 4, the distance sensor 262 is coupled a forward portion of the cab 16 of the refuse vehicle 10 so that, as the refuse vehicle 10 is driven along a path, the distance sensor 262 can capture sensor data forward of the refuse vehicle 10. In some embodiments, the distance sensor 262 is otherwise coupled to the cab 16. In various other embodiments, the distance sensor 262 is coupled to the lift assembly 40, the collection assembly 200, or is otherwise coupled to components of the refuse vehicle 10.

As shown in FIGS. 3 and 4, the lift arm actuators 44 and the articulation actuators 50 may be controlled by a control system for controlling the position of the collection assembly 200. The control system can provide control instructions to the lift arm actuators 44 and the articulation actuators 50 based on the image data provided by the cameras 260. In some embodiments, the control system can provide control instructions to the lift arm actuators 44 and the articulation actuators 50 based on the image data provided by the camera 260 and sensor data provided by the distance sensor 262.

In response to the image captured by the cameras 260 including the waste receptacle 110, for example in front of the refuse vehicle 10 in an alley, the lift arm actuators 44 and the articulation actuators 50 may be operated to move the forks 210 of the collection assembly 200 to a position (e.g., an engagement position, etc.) such that the forks 210 may engage the waste receptacle 110 and dump the waste receptacle 110 into the hopper volume of the refuse compartment 30 through an opening in the cover 36. In order to accomplish this, the control system that controls the lift arm actuators 44 and the articulation actuators 50 verifies whether a pose candidate derived from an image captured by the camera 260 matches a template representation corresponding to a target waste receptacle.

In order to verify whether a pose candidate matches a template representation, the template representation is first created. Pose candidates will be described in further detail below, after the creation of the template representations are described. In some embodiments, the control system that controls the lift arm actuators 44 and the articulation actuators 50 is configured to create the template representations. In other embodiments, a different system (e.g., a cloud system, an off-board computing system, a calibration system, an external system, etc.) is configured to create the template representation to the control system (e.g., to free up processing power of the control system, if the control system does not have sufficient processing power to create the template representations, if the template representations are created in a controlled environment, etc.).

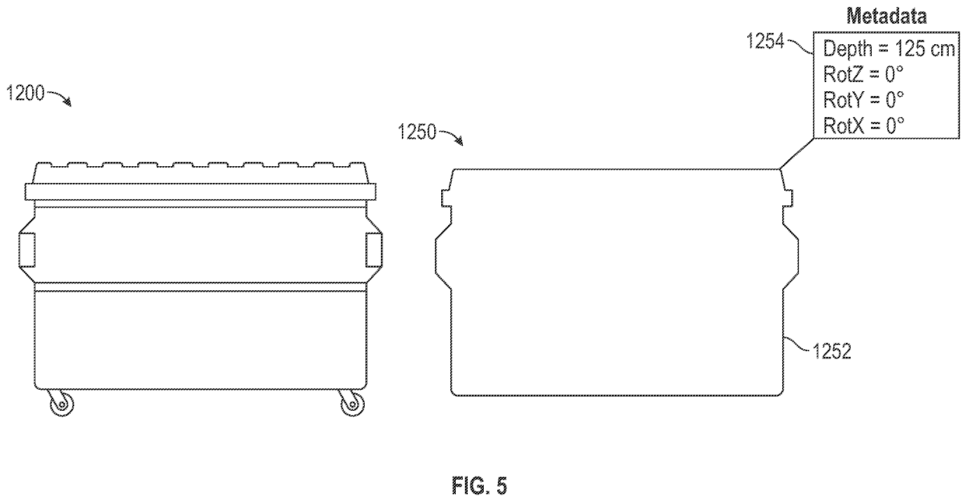

Referring to FIG. 5, there is shown an example of an object, shown as a waste receptacle 1200, and a representation of the object, shown as template representation 1250, created in respect of the waste receptacle 1200.

The template representation 1250 is created by capturing multiple images of the waste receptacle 1200 depicting different poses (e.g., orientations, angles, distances, etc.) of the waste receptacle 1200. These multiple images are captured by taking pictures at various angles and scales (e.g., depths, distances from, etc.) around the waste receptacle 1200 such that the template representation 1250 includes a representation of the waste receptacle 1200 from each of the various angles and scales. In some embodiments, the images are associated with specific orientation of the waste receptacle 1200 (e.g., an orientation of the waste receptacle 1200 that may be engaged by the collection assembly 200, etc.). For example, the images may focus on a front side of the waste receptacle 1200 of on the waste receptacle 1200 in an upright orientation such that the template representation 1250 corresponds to the front side of the waste receptacle 1200 or the waste receptacle 1200 in the upright position.

In some embodiments, the images are associated with ideal orientations of the waste receptacle 1200 that may be engaged by the collection assembly 200 (e.g., an operational orientation, a preferred orientation, etc.). For example, the images may be associated with a side of the waste receptacle 1200 that is ideally orientated toward the collection assembly 200 for the collection assembly 200 to engage the waste receptacle 1200 and empty the waste receptacle 1200 into the compartment 30. As another example, the images may be associated with a side of the waste receptacle 1200 where the apertures of the waste receptacle 1200 are orientated toward the collection assembly 200 such that the forks 210 of the collection assembly 200 may be moved forward to extend through the apertures of the waste receptacle 1200 for the collection assembly 200 to engage the waste receptacle 1200. The images associated with the ideal orientations of the waste receptacle 1200 may be used to form an ideal template representation that corresponds to the waste receptacle 1200 in the ideal orientations.

In other embodiments, the images are associated with non-ideal orientations of the waste receptacle 1200 that may not be engaged by the collection assembly 200. For example, the images may be associated with the waste receptacle 1200 in a sideways orientation that makes it difficult for the forks 210 of the collection assembly 200 to engage the waste receptacle 1200 and empty the waste receptacle into the compartment 30. The images associated with the non-ideal orientations of the waste receptacle 1200 may be used to form a non-ideal template representation that corresponds to the waste receptacle 1200 in the non-ideal orientations.

When a sufficient number of images have been captured of the waste receptacle 1200, the images are processed.

The final product of this processing is the template representation 1250 associated with the waste receptacle 1200. In particular, the template representation 1250 includes gradient information data 1252 and pose metadata 1254. The template representation 1250 includes a set of individual templates corresponding to each of the poses of the waste receptacle 1200 in each of the images of the waste receptacle 1200. In some embodiments, the template representation 1250 is associated with the ideal orientations of the waste receptacle 1200 (e.g., based on the images of the waste receptacle 1200 being of the waste receptacle 1200 in the ideal orientation, etc.). In other embodiments, the template representation 1250 is associated with the non-ideal orientations of the waste receptacle 1200 (e.g., based on the images of the waste receptacle 1200 being of the waste receptacle 1200 in the non-ideal orientation, etc.).

The gradient information data 1252 is obtained along the boundary of the waste receptacle 1200 as found in the multiple images. The pose metadata 1254 are obtained from pose information corresponding with each of the images, such as the angles and the distances at which each of the images was captured relative to the waste receptacle 1200 (e.g., the angles and the distances of the camera relative to the waste receptacle 1200 for each of the multiple images, etc.). For example, the pose metadata 1254 for the template representation 1250 shown in FIG. 5 includes a depth of 125 cm (e.g., the camera that captured the individual template shown of the template representation 1250 was 125 cm away from the waste receptacle 1200, etc.), with no rotation about the X, Y, or Z axes (e.g., the camera was angled straight on to a front of the waste receptacle 1200, etc.).

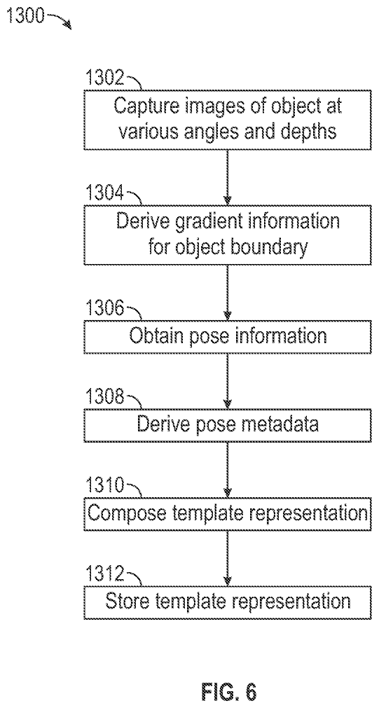

Referring to FIG. 6, there is shown a method 1300 for creating a template representation (e.g., a representation, a virtual representation, etc.) of an object. The method begins at step 1302, when images of the object are captured at various angles and scales. In some instances, the images of the object are captured by the camera 260. In other embodiments, the images of the objects are captured by a camera other than the camera 260 (e.g., a calibration camera, a camera not positioned on the refuse vehicle 10, etc.). Each of the images are associated with pose information, such as the depth of the camera (e.g., a distance of the camera from the object, etc.), and the three-dimensional position and/or rotation of the camera in respect of a reference point or origin (e.g., a reference point on the object, etc.).

At step 1304, gradient information is derived for the object boundary for each of the images captured by the camera. For example, as shown in FIG. 5, the gradient information is represented by gradient information data 1252. As is shown in FIG. 5, a gradient field including the gradient information data 1252 corresponds to the boundaries (e.g., edges, outline, etc.) of the waste receptacle 1200.

At step 1306, the pose information associated with each of the images is obtained. For example, this may be derived from the position of the camera relative to the object when each of the images were captured, which can be done automatically or manually, depending on the specific camera and system used to capture the images.

At step 1308, pose metadata is derived for each of the images based on the pose information associated with each of the images. The pose metadata is derived according to a prescribed or pre-defined format or structure such that the metadata can be readily used for subsequent operations such as verifying whether a pose candidate matches a template representation and/or determining a location of the pose candidate using the template representation.

At step 1310, a template representation is composed using the gradient information and pose metadata that were previously derived. As such, the template representation includes gradient information and associated pose metadata corresponding to each of the images captured.

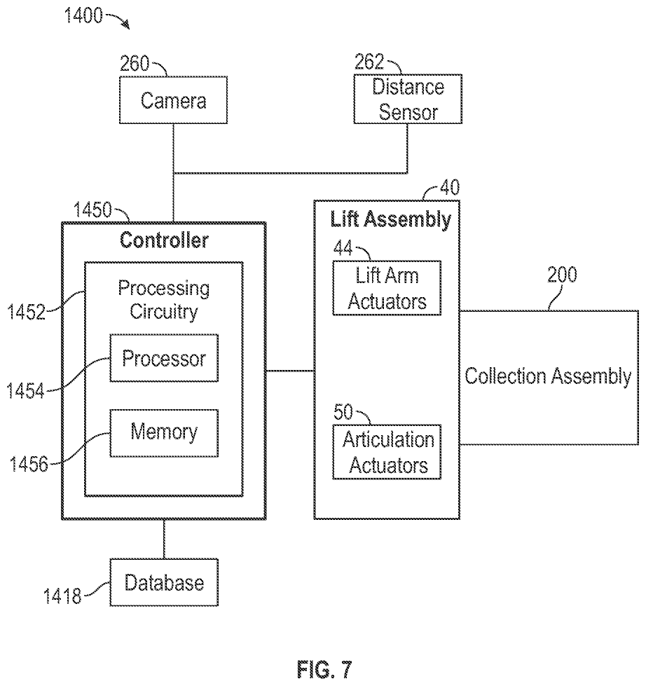

At step 1312, the template representation is stored so that it can be accessed or transferred for future use. Once the template representations have been created and stored, they can be used to verify pose candidates derived from real-time images, as will be described in further detail below. According to some embodiments, the template representations may be stored in a database. According to some embodiments, the template representations (including those in a database) may be stored on a non-transitory computer-readable medium. For example, the template representations may be stored in a database 1418, as shown in FIG. 7, and further described below.

Referring to FIG. 7, there is shown a system, shown as control system 1400, for detecting and engaging a waste receptacle (e.g., a waste retrieval system, a front loader system, etc.). The control system 1400 includes the camera 260, the distance sensor 262 the lift assembly 40, the collection assembly 200 and a controller (e.g., a control circuit, etc.), shown as controller 1450. In some embodiments, the controller 1450 also includes the database 1418. According to some embodiments, the control system 1400 is positioned on the lift assembly 40 and/or the collection assembly 200 (e.g., supported by the lift assembly 40 and/or the collection assembly 200, etc.). In other embodiments, a first portion of the control system 1400 is positioned on the lift assembly 40 and/or the collection assembly 200 and a second portion of the control system 1400 is not positioned on the lift assembly 40 or the collection assembly 200. For example, one of the cameras 260 may be positioned on the lift assembly 40, but a second of the cameras 260 and the controller 1450 may be positioned on the body 14 and the database 1418 may be positioned remote of the refuse vehicle 10 (e.g., in the cloud, etc.).

The controller 1450 includes processing circuitry 1452 including a processor 1454 and memory 1456. The processing circuitry 1452 can be communicably connected with a communications interface of controller 1450 such that processing circuitry 1452 and the various components thereof can send and receive data via the communications interface. The processor 1454 can be implemented as a general purpose processor, an application specific integrated circuit (ASIC), one or more field programmable gate arrays (FPGAs), a group of processing components, or other suitable electronic processing components.

The memory 1456 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 1456 can be or include volatile memory or non-volatile memory. The memory 1456 can include database components, object code components, script components, or any other type of information structure for supporting the various activities and information structures described in the present application. According to some embodiments, the memory 1456 is communicably connected to the processor 1454 via the processing circuitry 1452 and includes computer code for executing (e.g., by at least one of the processing circuitry 1452 or the processor 1454) one or more processes described herein.

The controller 1450 is configured to receive inputs (e.g., image data, sensor data, etc.) from the camera 260 and/or the distance sensor 262, according to some embodiments. In particular, the controller 1450 may receive the image data from the camera 260 associated with an object (e.g., the waste receptacle 110, etc.) located in the target area of the camera 260. The controller 1450 may be configured to provide control outputs (e.g., control decisions, control signals, etc.) to the lift arm actuators 44 and/or the articulation actuators 50 of the lift assembly 40 to operate the collection assembly 200 to engage the waste receptacle 110 and empty the waste receptacle into the compartment 30 based on the inputs received by the controller 1450. The controller 1450 may also be configured to receive feedback from the camera 260, the lift arm actuators 44, and/or the articulation actuators 50. In some embodiments, the controller 1450 is configured to provide updated control outputs to the lift arm actuators 44 and/or the articulation actuators 50 based on the feedback received by the controller 1450.

The database 1418 may be configured to store data, such as the template representation generated by the method 1300. The database 1418 may interface with the controller 1450 to provide the data stored in the database 1418 to the controller 1450. In some embodiments, the database 1418 is positioned on the refuse vehicle 10. In other embodiments, the database 1418 is a remote database that is external from the refuse vehicle 10. The database 1418 may interface with the controller 1450 through wiring or wirelessly (e.g., via a network, via Bluetooth, etc.) to provide the data stored in the database 1418 to the controller 1450.

In operation, the camera 260 captures real-time images forward of the collection assembly 200 as the refuse vehicle 10 is driven along a path and generates image data associated with the real-time images. For example, the path may be an alley with a commercial refuse container placed in the alley and the camera 260 may capture images of the commercial refuse container in the alley. The camera 260 provides (e.g., communicates, etc.) the image data associated with the real-time images to the controller 1450. In some embodiments, the image data may be communicated from the camera 260 to the controller 1450 using additional components such as memory, buffers, data buses, transceivers, etc. In some embodiments, the sensor data from the distance sensor 262 may be provided from the distance sensor 262 to the controller 1450. In various embodiments, the controller 1450 acquires the image data from the camera 260 and/or the sensor data from the distance sensor 262.

The controller 1450 is configured recognize if a waste receptacle is depicted in the image associated with the image data acquired from the camera 260 using the template representation stored in the database 1418. For example, the controller 1450 may analyze the image data to determine if the image associated with the image data depicts (e.g., includes, etc.) an object that corresponds to the template representation. If the controller 1450 determines that the image depicts an object that corresponds to the template representation, the controller 1450 may determine that a waste receptacle is located in the target area of the camera 260. In some embodiments, once the controller 1450 has determined that the waste receptacle is located in the target area of the camera 260, the controller 1450 may determine a location and/or orientation of the waste receptacle in the target area based on the image data and/or the sensor data from the distance sensor and provide control outputs (e.g., control signals, etc.) to the lift arm actuators 44 and/or the articulation actuators 50 of the lift assembly 40 to operate the collection assembly 200 to engage the waste receptacle based on the determined location and/or orientation. If the controller 1450 determines that the image data does not include an object that corresponds to the template representation, the controller 1450 may determine that a waste receptacle is not located in the target area of the camera 260.

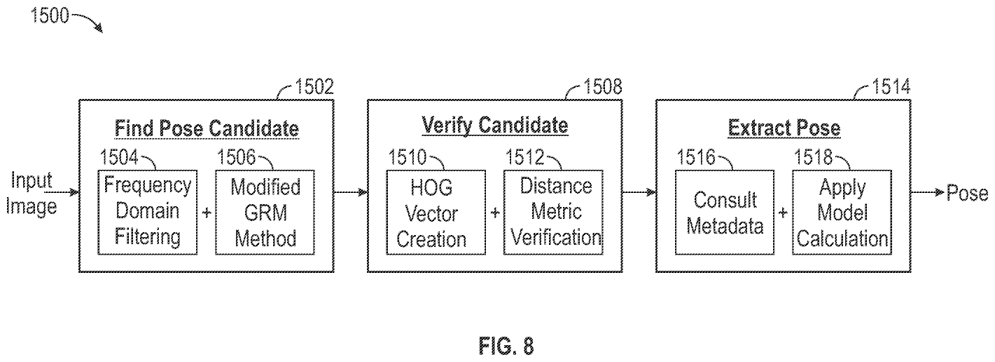

Referring to FIG. 8, a method 1500 for detecting and locating a waste receptacle is shown. In some embodiments, the method 1500 is performed by the controller 1450 to detect and locate a waste receptacle. In other embodiments, a different system performs the method 1500 to detect and locate a waste receptacle (e.g., an external system. etc.). For example, the controller 1450 may provide the image data to a cloud computing system (e.g., via a network, etc.) and the cloud computing system may detect and locate the waste receptacle. The method 1500 can be described as including step 1502 of generating a pose candidate, step 1508 of verifying the pose candidate, and step 1514 of calculating the location of the recognized waste receptacle (i.e., extracting the pose).

The step 1502 of generating the pose candidate can be described in terms of frequency domain filtering 1504 and a gradient-response map method 1506. The step 1508 of verifying the pose candidate can be described in terms of creating a histogram of oriented gradients (HOG) vector 1510 and a distance-metric verification 1512. The step 1514 of extracting the pose (in which the location of the recognized waste receptacle is calculated) can be described in terms of consulting the pose metadata 1516, and applying a model calculation 1518. The step of consulting the pose metadata 1516 generally requires retrieving the pose metadata from the database 1418.

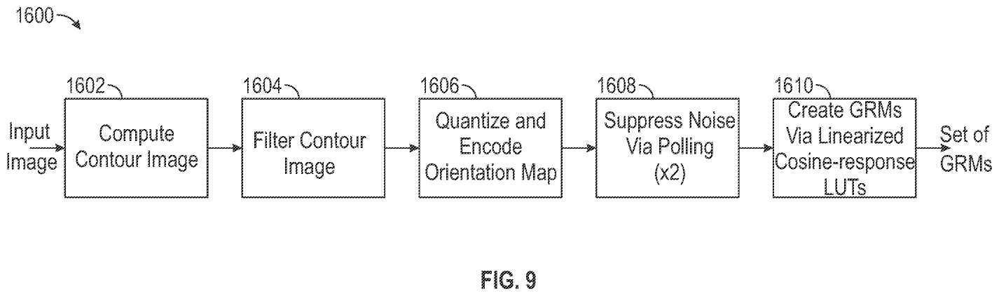

Referring to FIG. 9, there is shown a method 1600 for implementing the generating pose candidate of the step 1502 of the method 1500. The method 1600 is a modified Line2D for implementing the step 1502. A Line2D method can be performed by the controller 1450, and the instructions for a Line2D method may generally be stored in the memory 1456 of the controller 1450. In other embodiments, a different system performs the method 1600 to implement the step 1502 (e.g., an image processing system, etc.). For example, the controller 1450 may provide the image data to an external image processing system (e.g., via a network, etc.) and the external image processing system may implement the step 1502.

A standard Line2D method can be considered to include step 1602 that computes a contour image, step 1606 to quantize and encode an orientation map, step 1608 that suppresses noise via polling, and step 1610 to a create gradient-response maps (GRMs) via look-up tables (LUTs). In the method 1600 as depicted, step 1604 for filtering the contour image has been added as compared to the standard Line2D method. Furthermore, step 1608 for suppressing noise via polling and step 1610 for creating GRMs via LUTs have been modified as compared to the standard Line2D method.

The step 1604 for filtering the contour image converts the image to the frequency domain from the spatial domain, applies a high-pass Gaussian filter to the spectral component, and then converts the processed image data back to the spatial domain. The step 1604 that filters the contour image component can reduce the presence of background textures in the image, such as grass and foliage.

The step 1608 for suppressing noise via polling is modified from a standard Line2D method by adding a second iteration of the process to the pipeline. In other words, polling can be performed twice instead of once, which can help reduce false positives in some circumstances.

The step 1610 for creating GRMs via LUTs is modified from a standard Line2D method by redefining the values used in the LUTs. Whereas a standard Line2D method may use values that follow a cosine response, the values used in the step 1610 follow a linear response.

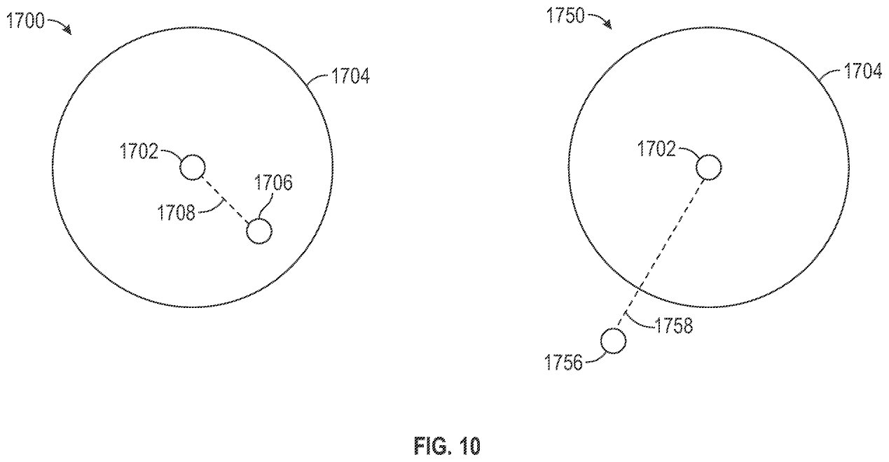

Referring to FIG. 10, there is shown a pictorial representation of the step 1508 of verifying the pose candidate. Two examples are shown in FIG. 10. The first example 1700 depicts a scenario in which a match is found between the HOG of the template representation and the HOG of the pose candidate. The second example 1750 depicts a scenario in which a match is not found.

In each example 1700 and 1750, the HOG of a template representation 1702 is depicted at the center of a circle that represents a pre-defined threshold 1704.

Example 1700 depicts a scenario in which the HOG of a pose candidate 1706 is within the circle. In other words, a difference 1708 (shown as a dashed line) between the HOG of the template representation 1702 and the HOG of the pose candidate 1706 is less than the pre-defined threshold 1704. In this case, a match between the pose candidate and the template representation can be verified.

Example 1750 depicts a scenario in which the HOG of a pose candidate 1756 is outside the circle. In other words, the difference 1758 between the HOG of the template representation 1702 and the HOG of the pose candidate 1756 is more than the pre-defined threshold 1704. In this case, a match between the pose candidate and the template representation cannot be verified.

Referring again to FIG. 8, when the match between the pose candidate and the template representation has been verified at step 1508, the method 1500 proceeds to the step 1514 of extracting the pose. The step 1514 of extracting the pose exploits the pose metadata stored during the creation of the template representation of the waste receptacle. This step calculates the location of the waste receptacle (e.g., the angle and scale) by comparing the pose candidate to the template representation and determining a data point of the pose metadata that corresponds with the pose candidate based on an alignment between the pose candidate and the template representation. For example, the pose candidate may be compared with the template representation to determine an orientation and/or location of the template representation relative to a portion of the vehicle (e.g., an angle relative to the template representation and/or a distance between the vehicle, lift arms, or collection assembly and the template representation, etc.) that corresponds with the pose candidate. The data point of the pose metadata can then be selected that corresponds with the orientation and/or location of the template representation relative to the portion of the vehicle. The orientation and/or the location of the waste receptacle relative to the portion of the vehicle may then be determined by using known geometry of the refuse vehicle 10 (e.g., a position of the camera 260 on the refuse vehicle 10, etc.) and the data point of the pose meta data that corresponds to the pose candidate.

In some embodiments, the location of the waste receptacle may be determined in relation to the collection assembly 200. For example, the location of the waste receptacle may include three dimensional coordinates relative to an origin at a point associated with the collection assembly 200. The location of the waste receptacle can be calculated using the pose metadata, the intrinsic parameters of the camera (e.g., focal length, feature depth, etc.), and a pin-hole model. For example, the pose candidate found during step 1508 may be compared to the pose meta data associated with the orientation of the template representation that corresponds with the pose candidate to determine a distance and an angle of the waste receptacle from the camera 260 positioned on one of the lift arms 42 by matching the pose candidate with the orientation of the template representation and determining the pose metadata associated with the orientation of the template representation. The location of the waste receptacle in relation to the collection assembly 200 may then be determined using the pose metadata and known geometry of the refuse vehicle 10 (e.g., the known geometry of the collection assembly 200, etc.).

Referring again to FIG. 7, once the location of the waste receptacle has been calculated, the controller 1450 can generate the control outputs for the lift arm actuators 44 and/or the articulation actuators 50 based on the location of the waste receptacle to operate the lift assembly 40 to position the forks 210 of the collection assembly 200 in an engagement position where the forks 210 may engage the waste receptacle. In other embodiments, the control outputs for the lift arm actuators 44 and/or the articulation actuators 50 may be provided by another controller other than the controller 1450, including controllers that are integrated with the lift arm actuators 44 and/or the articulation actuators 50, based on the location of the waste receptacle calculated by the controller 1450.

In some embodiments, the controller 1450 can also generate control outputs for the engine 18 and/or the wheels 20 of the refuse vehicle 10 based on the location of the waste receptacle to operate the engine 18 and the wheels 20 to move the refuse vehicle 10 in order to position the collection assembly 200 in the engagement position where the forks 210 may engage the waste receptacle. For example, if the lift arm actuators 44 are configured to rotate the lift arms 42 and the articulation actuators 50 are configured to articulate the collection assembly 200, the operation of the lift arm actuators 44 and the articulation actuators 50 may not be sufficient to position the forks 210 in the engagement position. For example, if the waste receptacle is positioned laterally relative to the forks 210 (e.g., to a side of the forks 210, etc.), the operation of the lift arm actuators 44 and the articulation actuators 50 may not be sufficient to position the forks 210 in the engagement position. As another example, if the waste receptacle is positioned forward relative to the forks 210, the operation of the lift arm actuators 44 and the articulation actuators 50 may be sufficient to align the forks 210 with the apertures defined by the waste receptacle, but the refuse vehicle 10 may need to be driven forward in order to position the forks 210 in the engagement position where the forks 210 extend through the apertures defined by the waste receptacle. As a result, the controller 1450 can generate the control outputs for the engine 18, the wheels 20, the lift arm actuators 44 and/or the articulation actuators 50 to position the collection assembly 200 in the engagement position.

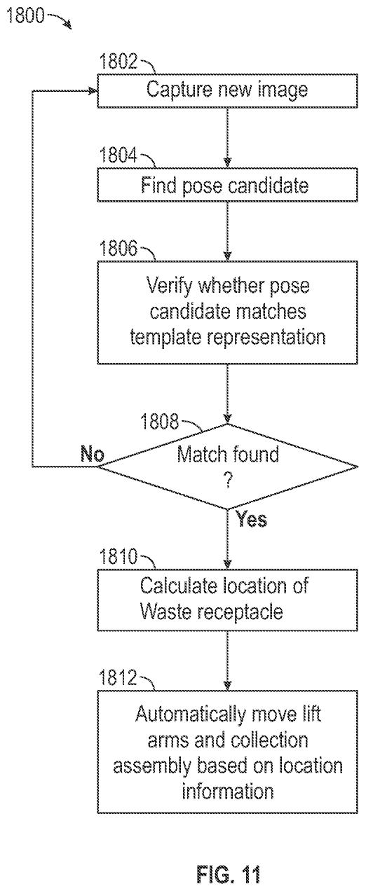

Referring to FIG. 11, there is shown a method for detecting and engaging a waste receptacle, shown as method 1800. In some embodiments, the method 1800 is performed by the controller 1450 to detect and engage the waste receptacle. In other embodiments, a different controller performs the method 1800 (e.g., a controller positioned on the refuse vehicle 10, a remote controller, etc.). The method 1800 begins at step 1802, when a new image is captured. For example, the new image may be captured by the camera 260, mounted on the refuse vehicle 10 as it is driven along a path. According to some embodiments, the camera 260 may be a video camera, capturing real-time images at a particular frame rate. In some embodiments, the method 1800 begins when a plurality of images are captured the plurality of the cameras 260 mounted on the refuse vehicle 10.

At step 1804, the method 1800 includes finding a pose candidate based on the image. For example, the method may identify a waste receptacle in the image.

According to some embodiments, step 1804 may include the steps of filtering the image and generating a set of gradient-response maps. For example, filtering the image may be accomplished by converting the image to the frequency domain, obtaining a spectral component of the image, applying a high-pass Gaussian filter to the spectral component, and then returning the image back to its spatial representation.

According to some embodiments, step 1804 may include a noise suppression step. For example, noise can be suppressed via polling, and, in particular, superior noise-suppression results can be obtained by performing the polling twice (instead of once). In some embodiments, the method 1800 includes finding a pose candidate based on each of the images captured by the cameras 260. In some embodiments, step 1804 includes finding the pose candidate based on the multiple of the images.

At step 1806, the method 1800 includes verifying whether the pose candidate matches the template representation. According to some embodiments, this is accomplished by comparing an HOG of the template representation with an HOG of the pose candidate. The difference between the HOG of the template representation and the HOG of the pose candidate can be compared to a pre-defined threshold such that, if the difference is below the threshold, then the method determines that a match has been found; and if the difference is above the threshold, then the method determines that a match has not been found. In some embodiments, the method 1800 includes verifying whether each of the pose candidates (e.g., a first pose candidate, a second pose candidate, etc.) associated with the multiple of the images (e.g., a first image, a second image, etc.) match the template representation.

At step 1808, the method 1800 includes querying whether a match between the pose candidate and the template representation during the step 1806. If a match is not found—i.e., if the waste receptacle (or other target object) was not found in the image—then the method returns to step 1802, such that a new image is captured, and the method proceeds with the new image. If, on the other hand, a match is found, then the method proceeds to step 1810. In some embodiments, the method 1800 includes querying if each of the matches between each of the pose candidates and the template representation.

In some embodiments, the method 1800 includes preventing the operation of the lift arm actuators 44 and/or the articulation actuators 50 if the match is not found between the pose candidate and the template representation. For example, if the pose candidate is associated with a vehicle and does not match the template representation associated with the waste receptacle, the operation of the lift arm actuators 44 and/or the articulation actuators 50 may be prevented such that the lift arm actuators 44 and/or the articulation actuators 50 do not come into contact with the vehicle. In some embodiments, the method 1800 includes preventing the operation of the lift arm actuators 44 and/or the articulation actuators 50 if the match is not found between a portion of the pose candidates and the template representation (e.g., if a number of the pose candidates where the match is found between the pose candidates and the template representation is less than a pose threshold, etc.). For example, if the match is found between a first of the pose candidates from a first image associated with a first of the cameras 260 and the template representation, but the match is not found between a second of the pose candidates from a second image associated with a second of the cameras 260 and the template representation and between a third of the pose candidates from a third image associated with a third of the cameras 260 and the template representation, the operation of the lift arm actuators 44 and/or the articulation actuators 50 may be prevented when the pose threshold is two due to only one match being found between the pose candidates and the template representation. Utilizing the pose threshold may decrease a likelihood of a false positive of the match between the pose candidates and the template representation.

At step 1810, the method 1800 includes calculating the location of the waste receptacle. According to some embodiments, the location can be determined based on the pose metadata stored in the template representation that matches the pose candidate. For example, once a match has been determined at step 1808, then, effectively, the waste receptacle (or other target object) has been found. Then, by querying the pose metadata associated with the template representation, the particular pose (e.g. the angle and scale or depth) corresponding to the pose candidate can be determined. In some embodiments, the location can be determined based on the pose metadata stored in the template representation corresponding to the pose candidate and the data from the distance sensor 262.

In some embodiments, the location of the waste receptacle can be determined based on the pose metadata corresponding with each of the pose candidates associated with each of the images captured by the cameras 260 (e.g., a first image captured by a first of the cameras 260, a second image captured by a second of the cameras 260, etc.) that match the template representation. By calculating different locations of each of the pose candidates from each of the cameras 260, the location of the waste receptacle may be verified. For example, if a first of the pose candidates of a waste receptacle from a first of the cameras 260 corresponds to a first data point of the pose metadata and a second of the pose candidates of the waste receptacle from a second of the cameras 260 taken at a different orientation relative to the waste receptacle (e.g., a different orientation from the first of the pose candidates of the waste receptacle, etc.) corresponds to a second data point of the pose metadata, the first data point may be used to determine a first pose location of the first of the pose candidates and the second data point may be used to determine a second pose location of the second of the pose candidates. If the first pose location and the second pose location are substantially the same location (e.g., a difference between the first pose location and the second pose location is less than a location error threshold, etc.), then the location of the waste receptacle may be considered verified and the location of the waste receptacle may be determined based on the first pose location of the first of the pose candidates and the second pose location of the second of the pose candidates. For example, if the first pose location and the second pose location are substantially the same location, the location of the waste receptacle may be determined to be the first pose location, the second pose location, or an average location between the first pose location and the second pose location. If the first pose location and the second pose location are not substantially the same (e.g., the difference between the first pose location and the second pose location is greater than the location error threshold, etc.), then the location of the waste receptacle may not be considered verified.

In some embodiments, the location of the waste receptacle can be determined based on the pose meta data corresponding with each of the pose candidates associated with each of the images captured by one of the cameras 260 that are captured when the one of the cameras 260 is in different positions. For example, the different positions of the cameras 260 may correspond to different position of the lift arms 42 (e.g., an raised position, a lowered position, etc.) when the one of the cameras 260 is positioned on the lift arms 42. As another example, the different positions of the one of the cameras 260 may correspond to different positions of the refuse vehicle 10 as the refuse vehicle 10 is driven along the path. The one of the cameras 260 may capture a first image when the refuse vehicle 10 is in a first position that may be used to generate a first of the pose candidates and a second image when the refuse vehicle 10 is in a second position that may be used to generate a second of the pose candidates. The first of the pose candidates and the second of the pose candidates can then be used to determine the location of the waste receptacle proximate the path of the refuse vehicle 10.

In some embodiments, a triangulated location of the waste receptacle may be determined by triangulating the pose meta data corresponding with each of the pose candidates. The triangulation of the pose meta data corresponding with each of the pose candidates may be used to determine the location of the waste receptacle or to verify the location of the waste receptacle determined based on the pose metadata. For example, the triangulated location of the waste receptacle may be determined by triangulating the location of the pose candidate using angles associated with the pose meta data corresponding with each of the pose candidates.

At step 1812, the method 1800 includes automatically moving the lift arms 42 and/or the collection assembly 200 based on the location information. The lift arms 42 and the collection assembly 200 may be moved via the lift arm actuators 44 and/or the articulation actuators 50. In some embodiments, the refuse vehicle 10 is automatically moved based on the location of the waste receptacle. The refuse vehicle 10 may be moved by the engine 18 and the wheels 20.

In some embodiments, the step 1812 includes automatically moving the lift arms 42 and/or the collection assembly 200 based on the location of the waste receptacle if the match is found between a portion of the pose candidates and the template representation (e.g., if a number of the pose candidates where the match is found between the pose candidates and the template representation is greater than a pose threshold, etc.). For example, if the match is found between a first of the pose candidates from a first image and the template representation and between a second of the pose candidates from a second image and the template representation, but the match is not found between a third of the pose candidates from a third image and the template representation, the lift arms 42 and/or the collection assembly 200 may still be moved automatically when the pose threshold is two due to two matches being found between the pose candidates and the template representation.

According to some embodiments, the lift arms 42 and/or the collection assembly 200 may be moved entirely automatically. In other words, the control system 1400 may control the precise movements of the lift arms 42 and/or the collection assembly 200 necessary for the forks 210 of the collection assembly 200 to engage the waste receptacle 110, tip refuse out of the waste receptacle 110 into the hopper volume of the refuse compartment 30 through an opening in the cover 36, and return the waste receptacle 110 to its original location, without the need for human intervention. In various embodiments, the refuse vehicle 10 may also be moved entirely automatically.

According to other embodiments, the collection assembly 200 may be moved automatically towards the waste receptacle 110, but without the precision necessary to move the waste receptacle 110 entirely without human intervention. In such a case, the control system 1400 may automatically move the collection assembly 200 into sufficient proximity of the waste receptacle such that a human user is only required to control the collection assembly 200 over a relatively short distance in order to engage the waste receptacle 110. In other words, according to some embodiments, the control system 1400 may move the collection assembly 200 most of the way towards a waste receptacle 110 by providing gross motor controls, and a human user (for example, using a joystick control), may only be required to provide fine motor controls. In some embodiments, the control system 1400 may automatically move the collection assembly 200 into sufficient proximity of the waste receptacle such that a human user is only required to control the refuse vehicle 10 over a relatively short distance (e.g., drive forward, etc.) in order to engage the waste receptacle. In various embodiments, the refuse vehicle 10 and/or the lift assembly 40 may also be moved automatically towards the waste receptacle, but without the precision necessary to move the waste receptacle entirely without human intervention. In such a case, the control system 1400 may automatically move the refuse vehicle 10 and/or the lift assembly 40 into sufficient proximity of the waste receptacle such that a human user is only required to control the refuse vehicle 10 and/or the lift assembly 40 over a relatively short distance in order to engage the waste receptacle.

In some embodiments, the step 1812 also includes monitoring a position of the collection assembly 200 during the automatic movement of the lift arms 42 and/or the collection assembly 200 to ensure that the collection assembly 200 reaches the engagement position where the forks 210 may engage the waste receptacle. For example, during the automatic movement of the lift arms 42 and/or the collection assembly 200 the camera 260 may continue to provide image data to the controller 1450 that includes images associated with the waste receptacle 110 and the collection assembly 200. The controller 1450 may make adjustments to the automatic movement of the lift arms 42 and/or the collection assembly 200 responsive to the controller 1450 determining that the original automatic movement of the lift arms 42 and/or the collection assembly 200 will not result in the collection assembly 200 reaching the engagement position based on the image data received from the camera 260 (e.g., based on feedback image data received from the camera 260, etc.). As another example, the controller 1450 may utilize the image data provided by the camera 260 during the automatic movement of the lift arms 42 and/or the collection assembly 200 to determine that the collection assembly 200 has not reached the engagement position. In some embodiments, the controller 1450 may utilize the image data to limit the operation of the refuse vehicle 10 until the collection assembly 200 has reached the engagement position. For example, the controller 1450 may limit the operation to limit the operation of the refuse vehicle 10 to prevent the refuse vehicle 10 from driving forward to extend the forks 210 through the apertures of the waste receptacle until the collection assembly 200 has reached the engagement position.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled”, and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the collection assembly 200, the system 1100, and components thereof as shown in the various exemplary embodiments is illustrative only. Additionally, any element disclosed in one embodiment may be incorporated or utilized with any other embodiment disclosed herein.

1. A system for detecting and engaging a waste receptacle, the system comprising:
a collection assembly configured to couple to a refuse vehicle, the collection assembly comprising:
a plurality of interface members configured to engage the waste receptacle, and
a camera configured to obtain image data associated with a target area proximate the interface members; and
a processor configured to:
generate, based on the image data, a pose candidate located within the target area,
verify if the pose candidate matches a template representation corresponding to the waste receptacle,
responsive to the pose candidate matching the template representation, determine a location of the waste receptacle, and
operate at least one of a lift arm actuator or an articulation actuator of a lift assembly to move the interface members based on the location of the waste receptacle.

2. The system of claim 1, wherein responsive to the pose candidate not matching the template representation, the processor is further configured to limit operation of at least one of the lift arm actuator or the articulation actuator.

3. The system of claim 1, wherein operation of the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into a refuse compartment of the refuse vehicle, lower the waste receptacle, and disengage the waste receptacle, wherein the interface members are positioned to engage the waste receptacle when the interface members are in the engagement position.

4. The system of claim 3, wherein prior to operating the interface members to engage the waste receptacle, the processor is further configured to:
determine, based on the image data, if the interface members are in the engagement position; and
responsive to the interface members not being in the engagement position, further operate the at least one of the lift arm actuator or the articulation actuator to move the interface members to the engagement position.

5. The system of claim 1, wherein:
the camera is a first camera; and
the collection assembly further comprises a second camera configured to obtain the image data associated with the target area proximate the interface members.

6. The system of claim 5, wherein the pose candidate is a first pose candidate generated based on the image data of the first camera; and
wherein the processor is further configured to:
generate, based on the image data of the second camera, a second pose candidate located within the target area,
verify if the second pose candidate matches the template representation corresponding to the waste receptacle, and
responsive to the second pose candidate matching the template representation, determine the location of the waste receptacle using the image data obtained by the first camera and the second camera to triangulate the location of the waste receptacle.

7. The system of claim 6, wherein the first camera is coupled to one of the interface members and the second camera is coupled to the refuse vehicle, wherein the first camera is configured to move with the interface members.

8. The system of claim 5, wherein the pose candidate is a first pose candidate generated based on the image data of the first camera; and
wherein the processor is further configured to:
determine a first pose location of the first pose candidate;
generate, based on the image data of the second camera, a second pose candidate located within the target area,
verify if the second pose candidate matches the template representation corresponding to the waste receptacle,
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

9. The system of claim 1, wherein the pose candidate is a first pose candidate generated based on the image data of the camera when the camera is in a first position; and
wherein the processor is further configured to:
determine a first pose location of the first pose candidate;
generate, based on the image data of the camera when the camera is in a second position, a second pose candidate located within the target area,
verify if the second pose candidate matches the template representation corresponding to the waste receptacle,
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

10. A refuse vehicle comprising:
a chassis;
a body defining a refuse compartment configured to receive refuse;
a lift assembly comprising:
lift arms pivotably coupled to the body,
a lift arm actuator coupled between the chassis and the lift arms configured to move the lift arms, and
an articulation actuator coupled to the lift arms,
a collection assembly coupled to a distal end of the lift arms, the collection assembly comprising:
a plurality of interface members configured to engage a waste receptacle, wherein the articulation actuator is configured to move the interface members relative to the lift arms, and
a camera configured to obtain image data associated with a target area proximate the interface members; and
a processor configured to:
generate, based on the image data, a pose candidate located within the target area,
verify if the pose candidate matches a template representation corresponding to the waste receptacle,
responsive to the pose candidate matching the template representation, determine a location of the waste receptacle, and
operate at least one of the lift arm actuator or the articulation actuator to move the interface members based on the location of the waste receptacle.

11. The refuse vehicle of claim 10, wherein responsive to the pose candidate not matching the template representation, the processor is further configured to limit operation of at least one of the lift arm actuator or the articulation actuator.

12. The refuse vehicle of claim 10, wherein operation of the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into the refuse compartment of the refuse vehicle, lower the waste receptacle, and release the waste receptacle, wherein the interface members are positioned to engage the waste receptacle when the interface members are in the engagement position.

13. The refuse vehicle of claim 12, wherein prior to operating the interface members to engage the waste receptacle, the processor is configured to:
determine, based on the image data, if the interface members are in the engagement position; and
responsive to the interface members not being in the engagement position, further operate the at least one of the lift arm actuator or the articulation actuator to move the interface members to the engagement position.

14. The refuse vehicle of claim 10, wherein the pose candidate is a first pose candidate generated based on the image data of the camera when the camera is in a first position; and
wherein the processor is further configured to:
determine a first pose location of the first pose candidate;
generate, based on the image data of the camera when the camera is in a second position, a second pose candidate located within the target area,
verify if the second pose candidate matches the template representation corresponding to the waste receptacle,
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

15. The refuse vehicle of claim 14, responsive to the difference between the first pose location and the second pose location being greater than the location error threshold, the processor is further configured to configured to limit operation of the refuse vehicle.

16. A method for detecting and engaging a waste receptacle, the method comprising:
generating, based on image data obtained by a camera of a collection assembly of a refuse vehicle, a pose candidate located within a target area proximate the interface members;
verifying if the pose candidate matches a template representation corresponding to the waste receptacle;
responsive to the pose candidate matching the template representation, determining a location of the waste receptacle, and
operating at least one of a lift arm actuator configured to move lift arms of the refuse vehicle or an articulation actuator configured to move a plurality of interface members of the collection assembly relative to the lift arms to move the interface members based on the location of the waste receptacle.

17. The method of claim 16, wherein responsive to the pose candidate not matching the template representation, the method further comprises limiting operation of at least one of the lift arm actuator or the articulation actuator.

18. The method of claim 16, wherein operating the at least one of the lift arm actuator or the articulation actuator includes operating the at least one of the lift arm actuator or the articulation actuator to move the interface members to an engagement position, engage the waste receptacle with the interface members, lift the waste receptacle, empty contents of the waste receptacle into a refuse compartment of the refuse vehicle, lower the waste receptacle, and disengage the waste receptacle, wherein the interface members are positioned to engage the waste receptacle when the interface members are in the engagement position.

19. The method of claim 18, wherein prior to operating the interface members to engage the waste receptacle, the method further comprises:
determining, based on the image data, if the interface members are in the engagement position; and
responsive to the interface members not being in the engagement position, further operating the at least one of the lift arm actuator or the articulation actuator to move the interface members to the engagement position.

20. The method of claim 19, wherein the pose candidate is a first pose candidate generated based on the image data of the camera when the camera is in a first position; and
wherein the method further comprises:
determining a first pose location of the first pose candidate,
generating, based on the image data of the camera when the camera is in a second position, a second pose candidate located within the target area,
verifying if the second pose candidate matches the template representation corresponding to the waste receptacle,
responsive to the second pose candidate matching the template representation, determining a second pose location of the second pose candidate; and
responsive to a difference between the first pose location and the second pose location being less than a location error threshold, determining that the location of the waste receptacle is at least one of the first pose location, the second pose location, or an average of the first pose location and the second pose location.
